(19) United States
(12) Patent Application Publication
(10) Pub. No.: US 2003/0137759 A1
(43) Pub. Date: Jul. 24, 2003

(54) Silicon wafer based rotatable mirror

(76) Inventor: Joseph T. Pesik, Eagen, MN (US)

Correspondence Address: CALFEE HALTER & GRISWOLD, LLP, 800 SUPERIOR AVENUE, SUITE 1400, CLEVELAND, OH, 44114, US

(21) Appl. No.: 10/056,199

(22) Filed: Jan. 24, 2002

(51) Int. Cl. G02B 26/08; G02B 5/08; G02B 7/192; G02B 7/182

(52) U.S. Cl. 359/883; 359/214; 359/848

(57) ABSTRACT

A rotatable mirror comprises: a substrate of at least one wafer of Silicon material, the substrate including a polished, flat surface of a predetermined shape; and a reflective medium disposed on the flat polished surface of the substrate, the medium being selected for an at least one wavelength of radiation to be reflected thereby. The rotatable mirror may be used in a mirror system for rotational scanning a radiation beam. In this system, the rotatable mirror is coupled to and rotated by a mirror drive mechanism in at least plane of rotation

### BACKGROUND OF THE INVENTION

The present invention relates to precision optical mirrors for rotational scanning applications, in general, and more particularly to a Silicon wafer based rotatable mirror.

Conventional precision mirrors for rotational scanning applications generally include a substrate material which has one surface highly polished and coated with a reflective medium. In operation, these precision mirrors are typically mounted to a drive mechanism, such as a resonant scanner, for example, for rotational scanning of an optical beam incident upon the reflective medium. Common substrate materials include BK-7, Pyrex, Zerodur, Aluminum and the like, for example. (BK-7 and Zerodur are trademarks or tradenames of Schott Corporation and Pyrex is a trademark or tradename of Coming Corporation) For rotational scanning operation, the substrates should be lightweight and highly resistant to deflection. This is measured by a specific stiffness value (E/p), i.e. Young's Modulus divided by density (rho). The required stiffness for conventional substrates is generally achieved with a high thickness to diameter ratio, but this results in undesirable added mass to the mirror. This added mass has an impact on the scan drive requirements of the drive mechanism, the attainable resonant frequency of the mirror and the overall optical system architecture in both cost and weight.

In some applications, like use in an aircraft environment, for example, a precision rotatable mirror encounters substantial temperature extremes during flight profiles. In these applications, it is desirable to have a mirror that is highly resistant to thermal distortion over a wide operating temperature range. In addition, the reflective surface of these precision mirrors may need to take upon a variety of shapes based on the particular application. The current substrate materials are not easily and/or inexpensively shaped for different applications. For example, to reshape a standard glass substrate from a simple circular shape to an elliptical shape, a basic solid glass cylinder is often sectioned at a forty-five degree (45°) angle which causes the sides to be beveled. This can make it more difficult to effectively balance and mount the elliptically shaped mirror to the drive mechanism since the center of mass of the mirror will not coincide with the desired rotational center of the reflective surface.

Accordingly, for rotational scanning applications, it is desirable to have a precision mirror with a substrate material that is highly available and can be easily and inexpensively altered in shape. It is also desirable to have such substrate material include high strength and low weight characteristics and offer good resistance to thermal distortion over wide operating temperature ranges. Such properties in a mirror can minimize the scan drive requirements and overall optical system architecture rendering a lighter weight and more cost-effective optical system than what currently exists.

### SUMMARY OF THE INVENTION

In accordance with one aspect of the present invention, a rotatable mirror comprises: a substrate of at least one wafer of Silicon material, the substrate including a polished, flat surface of a predetermined shape; and a reflective medium disposed on the flat polished surface of the substrate, the medium being selected for an at least one wavelength of radiation to be reflected thereby.

In accordance with another aspect of the present invention, a mirror system for rotational scanning a radiation beam comprises: the rotatable mirror as described above; and a mirror drive mechanism, wherein the rotatable mirror being coupled to and rotated by the drive mechanism in at least plane of rotation

### BRIEF DESCRIPTION OF THE DRAWINGS

FIGS. 1A and 1B illustrate front and side views, respectively, of an exemplary rotatable mirror configuration 10 in accordance with one aspect of the present invention.

FIG. 2 is an illustration of a scanning optical system using the rotatable mirror in accordance with another aspect of the present invention.

### DETAILED DESCRIPTION OF THE INVENTION

As is well known to the semiconductor industry, Silicon wafers are used as substrates in the manufacture of semiconductor circuits. The Silicon material used for the wafers is generally made in the form of ingots which are grown by conventional processes. The Silicon ingots which are generally cylindrical in shape are sliced to yield wafers of substantially circular shape and predetermined thickness. Thus, Silicon wafers in this form are considered readily available for other applications as well. Applicant has discovered that the high strength and low weight properties of these Silicon wafers render them well suited for rotatable mirrors as will become more evident from the following description.

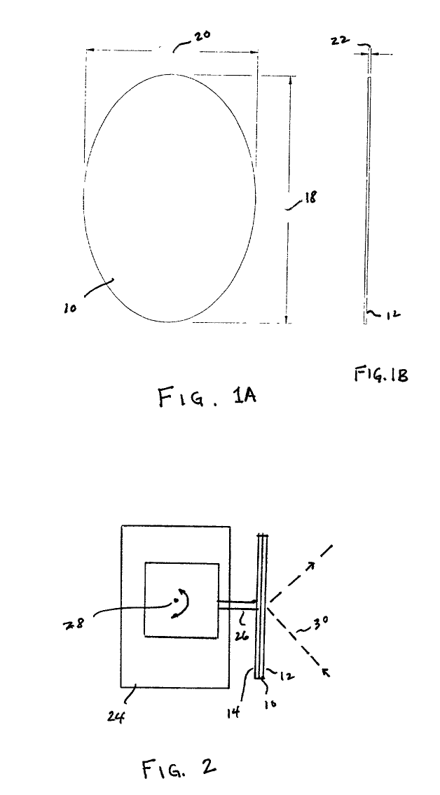

In accordance with the present invention, at least one Silicon wafer is used as a substrate for a rotatable mirror. FIGS. 1A and 1B illustrate front and side views, respectively, of an exemplary rotatable mirror configuration 10 in accordance with one aspect of the present invention. The rotatable mirror 10 may be configured into any shape based on its particular application. In the instant example, the shape of the mirror 10 is elliptical. For other applications, the mirror could be round, square, rectangular, octagonal or any other imaginable shape, at virtually no increase in cost. If round or circular, the mirror may leverage the size of existing SEMI standard wafers. Virtually any shape can be readily machined or laser cut from standard wafer diameters with only the limitation of thickness, based on the machining or laser cutting capabilities. More over, Silicon wafers may be machined or laser cut into close tolerance precision mirror substrates with flat surfaces to meet various thickness and surface finish specifications.

One flat surface or functional surface 12 of the wafer substrate may be polished before machining or laser cutting. Once the final shape is achieved, an optical coating of a reflective medium, like gold or silver or other desirable coating, including a dielectric, for example, may be applied to the polished functional surface 12, by sputtering or other conventional process, for example, to a predetermined thickness. The resulting rotatable mirror 10 may have a substrate in the form of a single Silicon wafer, a composite of a plurality of bonded Silicon wafers or either of the aforementioned arrangements disposed on or bonded to a backing plate 14 as shown in the illustration of FIG. 2. The backing plate 14 may be made of a material selected from the group comprising a metal, plastic, ceramic, glass or the like, for example. The rotatable mirror 10 of the present embodiment is elliptical in shape with a long axis diameter dimension 18 of 2.828 inches or 71.83 millimeters and a short axis diameter of 2.0 inches or 50.81 millimeters and a thickness of 0.028 inches or 0.71 millimeters, but it is understood that the mirror may be configured to any shape and size to meet the specifications of a particular application. The rotatable mirror 10 is effective in small miniature electromechanical system (MEMS) configurations as well as mid-range (diameter of 3-8 inches) and possibly larger optical configurations and may be coated for specific wavelength or broadband applications. It may also be customized for compatibility with a variety of scanning techniques.

Materials of current mirror substrates cannot be manipulated to any desired shape as inexpensively as the Silicon wafer based substrate, if at all. One aspect of an elliptical shaped silicon wafer based mirror is the continuous cross section thereof. That is, the sides are normal to the faces along the entire perimeter. For standard glass substrates, for example, an elliptical shape is often developed by cutting a solid glass cylinder at a 45° angle which causes the sides to be beveled. This can make it more difficult to effectively balance and mount the elliptically shaped mirror to the drive mechanism since the center of mass of the mirror will not coincide with the desired rotational center of the reflective surface.

The Silicon wafer based rotatable mirror of the present embodiment is highly resistant to deflective distortions, having a Specific Stiffness (E/p), that is Young's Modulus divided by density (rho), on the order of 1.5-2.5 times better than BK-7, Zerodur, Aluminum and other similar precision mirror substrate materials. Consequently, the rotatable mirror 10 has a lower thickness to diameter ratio than the current standard mirror designs. This weight and profile reduction is critical in dynamic optical scanning applications to minimize scan drive mechanism requirements and overall optical system architecture. The Silicon wafer based rotatable mirror of the present embodiment is also very resistant to thermal distortion, having a Thermal Distortion Coefficient on the order of 0.020-0.032 which is better than Zerodur and one to two orders of magnitude better than Aluminum, BK-7 and other similar materials. This property provides a mirror with much greater resistance to the negative impact of substantial temperature extremes, like those encountered in aircraft flight profiles, for example.

One application of the rotatable mirror 10 is in a wide field scanning optical system on board an aircraft wherein the mirror 10 may be coupled to and rotated by a mirror drive mechanism 24 as shown in the illustration of FIG. 2. In the present embodiment, the mirror drive mechanism 24 comprises an off-the-shelf resonant scanner, which may be of the type manufactured by Lasesys Corporation, for example. In the embodiment of FIG. 2, the backing plate 14 of the mirror 10 is coupled to a shaft 26 of the mechanism 24 thus keeping exposed the reflective medium of the surface 12. The drive mechanism 24 may be operated in two planes of rotation, one about an axis 28 appearing perpendicular to the page and the other about the axis of the shaft 26. In this configuration, a radiation beam 30 may be rotatably scanned by the mirror system. The reflective medium of the surface 12 may be selected for an at least one wavelength of the radiation 30 rotatably scanned thereby. Accordingly, the surface 12 may be coated for specific wavelength transmission or broadband coated.

The reduced mass of the rotatable mirror 10 allows the drive mechanism 24 to attain a higher target operating frequency while providing a sufficiently large reflective surface 12. Similar face-area mirrors manufactured from contemporary optical substrates such as Pyrex, BK7, Aluminum and Zerodur would be provided with a considerably thicker cross-section to maintain strength and flatness. This additional mass would not allow the drive mechanism to reach the target operating frequency. This is a credit to the higher specific stiffness of Silicon substrate compared to these other materials.

Silicon wafer based mirrors may be suitable for static applications as well. The Silicon wafer mirror could be kinematically bonded to some structure or to other wafers to increase overall thickness.

Flatness requirements of the mirror should be also considered, based on the mirror's application. Flatness is usually identified in terms of wavelengths. One configuration of a rotatable mirror according to the present embodiment has been measured to have approximately a 3 lambda flatness at 633 nanometers (nm) which equates to a 1.2 lambda flatness at 1550 nm, for example. This flatness is sufficient for non-coherent wide field scanning applications and possibly imaging applications. However, tighter flatness specifications would be accommodated for the rotatable mirror to be effective in coherent applications.

Operating loads to the elliptical mirror 10 in the mirror system application of FIG. 2 were analyzed by Finite Element Analysis and the results indicated a Silicon wafer yield stress of two to twenty times greater than the actual induced stress on the mirror 10 in the wide field scanning application. This range in safety factor is due to the variables in different Silicon wafer lattice structures and manufacturing processes. Accordingly, appropriate specifications for the wafer could control this for any specific mirror application. Also, the mirror system of FIG. 2 was vibration tested to reasonable energy levels for some current helicopters. The mirror performed well during random vibration at levels up to and including 0.020 g\hat{ }2/Hz and then during a sine sweep from 10-500 Hz with a 2 g peak. MilStd-810E, Environmental Test Methods, and RTCA/DO-160, Environmental Conditions and Test Procedures for Airborne Equipment, served as a reference these test procedures.

The mirror system of FIG. 2 was thermal cycled, while not operating, between 55° C. and +85° C. for two complete cycles and while operating, between −40° C. and +60° C., for two cycles. Each test involved ramping at 5° C./minute, stabilizing at the desired temperature extreme for 1.5 hours and then ramping to the next extreme. The mirror 10 itself showed no degradation as a result of this testing. These temperature limits are standard for military aircraft applications. Mil-Std-810E was used as the testing basis.

Accordingly, the high strength and low weight properties of the Silicon wafer based rotatable mirror 10 of the present embodiments provide positive reliability impact through reduced drive mechanism load requirements and overall optical system mass reduction. The high availability and ease of configurablity of the Silicon wafers ensures the rotatable mirror of the present embodiment to be a cost-effective replacement to conventional optical rotatable mirrors at a fraction of the weight.

While the present invention has been described by way of example in connection with one or more embodiments herein above, it is understood that such embodiments should in no way, shape or form limit the present invention. Rather, the present invention should be construed in breadth and broad scope in accordance with the recitation of the claims appended hereto.

What is claimed is:

1. A rotatable mirror comprising:
a substrate of at least one wafer of Silicon material, said substrate including a flat surface of a predetermined shape, said flat surface being polished; and
a reflective medium disposed on the flat polished surface of said substrate, said medium being selected for an at least one wavelength of radiation to be reflected thereby.

2. The rotatable mirror of claim 1 wherein the substrate is a single wafer of the Silicon material.

3. The rotatable mirror of claim 1 wherein the substrate is a bonded composite of a plurality of wafers of the Silicon material.

4. The rotatable mirror of claim 1 including a backing plate; and wherein the substrate is disposed on the backing plate exposing the reflective medium.

5. The rotatable mirror of claim 4 wherein the backing plate comprises a material selected from the group comprising metal, plastic, ceramic and glass.

6. The rotatable mirror of claim 1 wherein the reflective medium is disposed on the flat polished surface by coating to a predetermined thickness.

7. The rotatable mirror of claim 1 wherein the reflective medium is disposed on the flat polished surface by sputtering to a predetermined thickness.

8. The rotatable mirror of claim 1 wherein the reflective medium is selected from the group comprising gold, silver and dielectric material.

9. The rotatable mirror of claim 1 wherein the mirror has a thermal distortion coefficient in the range of 0.020 to 0.032.

10. The rotatable mirror of claim 1 wherein the at least one wafer of the substrate being sectioned from a Silicon ingot.

11. The rotatable mirror of claim 10 wherein the shape of the at least one wafer sectioned from the Silicon ingot is substantially a circle.

12. The rotatable mirror of claim 11 wherein the circle shape is altered into another different shape based on an application of the mirror.

13. The rotatable mirror of claim 12 wherein the circle shape is altered into the other different shape by laser cutting.

14. The rotatable mirror of claim 12 wherein the circle shape is altered into the other different shape by machining.

15. A mirror system for rotational scanning a radiation beam, said system comprising:
a rotatable mirror comprising:
a substrate of at least one wafer of Silicon material, said substrate including a flat surface of a predetermined shape, said flat surface being polished; and
a reflective medium disposed on the flat polished surface of said substrate, said medium being selected for an at least one wavelength of radiation to be rotatably scanned thereby; and
a mirror drive mechanism, wherein said rotatable mirror being coupled to and rotated by said drive mechanism in at least plane of rotation

16. The system of claim 15 wherein the substrate is a single wafer of the Silicon material.

17. The system of claim 15 wherein the substrate is a bonded composite of a plurality of wafers of the Silicon material.

18. The system of claim 15 including a backing plate; wherein the substrate is disposed on the backing plate exposing the reflective medium; and wherein the backing plate is coupled to the mirror drive mechanism.

19. The system of claim 15 wherein the mirror drive mechanism is operative in two planes of rotation.

20. The system of claim 15 wherein the mirror drive mechanism comprises a resonant scanner.
